(19) United States
(12) Patent Application Publication
(10) Pub. No.: US 2013/0212310 A1
(43) Pub. Date: Aug. 15, 2013

(54) INTERFACE FOR MODULAR INPUT/OUTPUT AND DATA ACQUISITION SYSTEMS

(71) Applicant: RED LION CONTROLS, INC., (US)

(72) Inventors: Jesse BENEFIEL, III, York, PA (US); Michael John GRANBY, York, PA (US)

(73) Assignee: RED LION CONTROLS, INC., York, PA (US)

(21) Appl. No.: 13/764,393

(22) Filed: Feb. 11, 2013

Related U.S. Application Data
(60) Provisional application No. 61/598,721, filed on Feb. 14, 2012.

(51) Int. Cl. G06F 13/42

(52) U.S. Cl. CPC G06F 13/4282
USPC 710/106

(57) ABSTRACT

A modular I/O and data acquisition system includes a plurality of connection ports for receiving mating connectors of an interconnecting I/O module, the mating connectors configured to mate with a plurality of contacts in an associated connection port. The plurality of ports is mounted in an equipment rack. The equipment rack includes wiring interconnections, power buses and data buses for communication with automation devices. Connection ports include an interface circuit. The interface circuit includes a power source, a pair of USB data signal lines transmitting a USB data signal, and an optional video channel independent from the USB data signal.

### CROSS-REFERENCE TO RELATED APPLICATIONS

This patent application claims the benefit of U.S. Provisional Patent Application Ser. No. 61/598,721 filed Feb. 14, 2012, entitled INTERFACE FOR MODULAR INPUT/OUTPUT AND DATA ACQUISITION SYSTEMS, the disclosure of which is hereby incorporated by reference herein in its entirety and made part of the present U.S. utility patent application for all purposes.

### BACKGROUND

The application generally relates to data interfaces. The application relates more specifically to a custom Universal Serial Bus (USB) interface for modular I/O HMIs and data acquisition systems.

Currently industrial automation includes multi-zone PID control, data acquisition and I/O into a personal computer (PC), distributed control system (DCS) or programmable logic control (PLC) system. Currently industrial controls and data acquisition systems operate at various signal and power levels, e.g., zero to 5 volts DC, zero to 10 volts DC, 4 to 20 milliamperes DC (mA DC) and +/−10 VDC. Meanwhile other industrial automation devices have greater power requirements, e.g., +/−24 VDC.

Universal Serial Bus (USB) is a computer industry standard that defines the cables, connectors and communications protocols used in a bus for connection, communication and power supply between computers and electronic devices. USB provides a standardized connection for computer peripherals, for example keyboards, pointing devices, printers, portable media players, disk drives and network adapters to personal computers, both to communicate and to supply electric power. USB is commonly used on other digital devices as well, such as smart phones, personal digital assistants (PDA) and video game consoles. USB replaces a variety of earlier interfaces such as serial and parallel ports, as well as separate power chargers for portable devices.

Universal Serial Bus (USB) provides a high data rate and hot-swappable connections for PCs, and a connection to a wide variety of multimedia and network USB devices. While USB has traditionally been applied for home or office use, USB has recently found application in industrial applications. One of the difficulties of using USB for industrial automation and controls is that a wider range of power requirements and protocols is used in industry than in home/office devices, which sometimes prevents the use of the USB protocol and/or connectors. The USB 2.0 standard power supply limit is 5 VDC at 500 milliamperes, with maximum power draw of 2.25 watts.

What is needed is a custom interface which provides expandability for industrial automation equipment, e.g., modular I/O controllers and Human Machine Interface (HMI) devices, in combination with USB features. When combined with voltage and power greater than the standard USB voltages and power, such an interface may be used for interconnection of a wider variety of industrial automation equipment and devices.

Intended advantages of the disclosed systems and/or methods satisfy one or more of these needs or provide other advantageous features. Other features and advantages will be made apparent from the present specification. The teachings disclosed extend to those embodiments that fall within the scope of the claims, regardless of whether they accomplish one or more of the aforementioned needs.

### SUMMARY

An apparatus for a custom USB interface for a modular I/O and data acquisition systems which includes a connection port having a separate power source and a pair of USB data signal lines.

One embodiment relates to an interface circuit for a modular input/output (I/O) human-machine interface (HMI) and data acquisition system. The interface circuit includes a connection port having a power source, a pair of USB data signal lines transmitting a USB data signal.

Another embodiment relates to a modular I/O and data acquisition system. The modular I/O and data acquisition system includes a plurality of connection ports for receiving mating connectors of an interconnecting I/O module, the mating connectors configured to mate with a plurality of contacts in an associated connection port. The plurality of ports is mounted in an equipment rack. The equipment rack includes wiring interconnections, power buses and data buses for communication with automation devices. Connection ports include an interface circuit. The interface circuit includes a power source, a pair of USB data signal lines transmitting a USB data signal, and an optional video channel independent from the USB data signal.

Another embodiment relates to an HMI that includes a connection port having a separate power source and a pair of USB data signal lines. Connection ports are configured to receive mating connectors of an interconnecting I/O module. The mating connectors mate with contacts in an associated connection port. Connection ports include an interface circuit. The interface circuit includes a power source, a pair of USB data signal lines transmitting a USB data signal, and an optional video channel independent from the USB data signal.

Certain advantages of the embodiments described herein are the ability to provide increased power for auxiliary devices along with a USB data signal, with an optional video support channel.

Alternative exemplary embodiments relate to other features and combinations of features as may be generally recited in the claims.

### BRIEF DESCRIPTION OF THE FIGURES

FIG. 1 shows a pin connection arrangement of an exemplary custom data and power interface.

FIG. 2 shows a schematic interconnection diagram of an exemplary interface.

FIG. 3 shows a modular I/O and data acquisition system having multiple ports for interconnecting I/O modules.

FIG. 4 shows an exemplary I/O module with the custom data and power interface of FIGS. 1 and 2.

FIG. 5 shows a rear isometric view of an exemplary HMI with the custom data and power interface of FIGS. 1 and 2.

FIG. 6 shows a front view of an exemplary HMI.

### DETAILED DESCRIPTION OF THE EXEMPLARY EMBODIMENTS

The disclosure describes a custom USB interface for modular I/O HMIs and data acquisition systems. A hosting system provides power via a 24 volts DC bus over four connector pins. Two pair of 24 vdc power and 24 vdc common pins are provided on the custom USB interface. In one embodiment the system input power supply may be conditioned, e.g., filtered and reverse polarity protected, and bussed to the connectors to provide 24 vdc power to the module electronics. Maximum current may depend on the desired ampacity of the circuit components.

The disclosed system is preferably modular to support of a variety of peripheral or external devices, for example, input/output (I/O), control, and communications devices. I/O may include simple I/O modules with limited functionality as it relates to computational tasks. Further exemplary I/O devices include analog process inputs and outputs; digital inputs and outputs; thermocouple inputs; and resistance temperature detector (RTD) inputs.

Control devices may include single & multiple loop proportional-integral-derivative (PID) control modules, motor and or servo controllers, and deterministic logic controller. Communications devices may include 4/8-port Ethernet switches, modems geographic positioning system (GPS) receivers, and proprietary communication protocols and systems for industrial automation, such as Foundation Fieldbus, Profibus and DeviceNet.

An optional video support may be provided via a single differential pair on a specific video hardware channel to improve system performance and video performance.

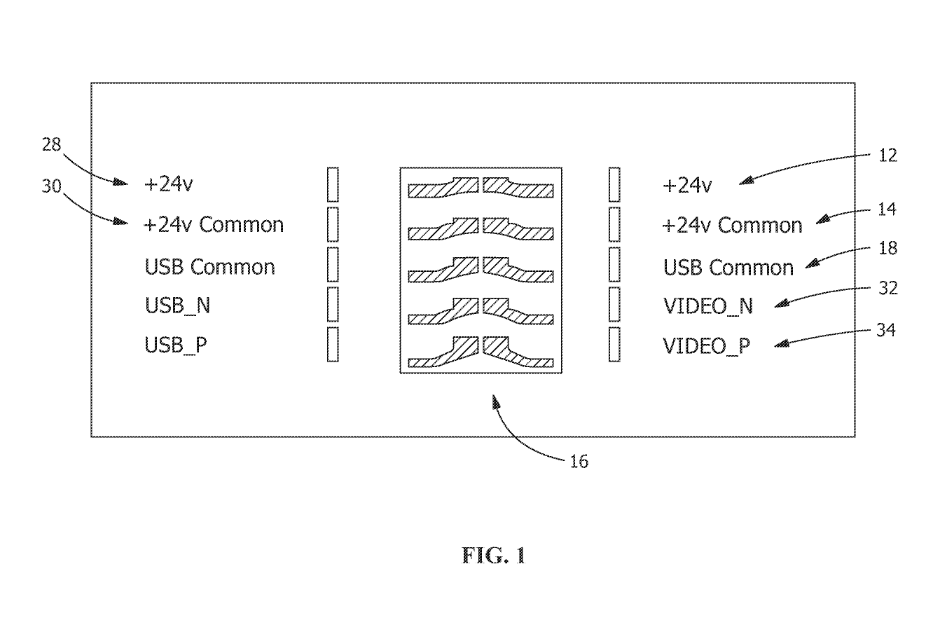

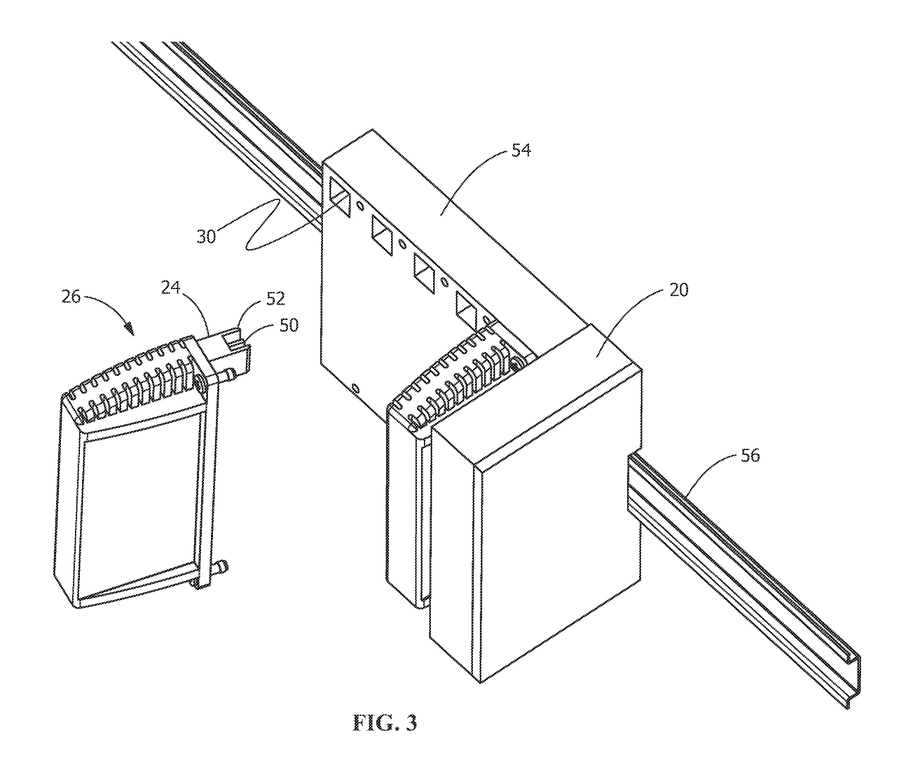

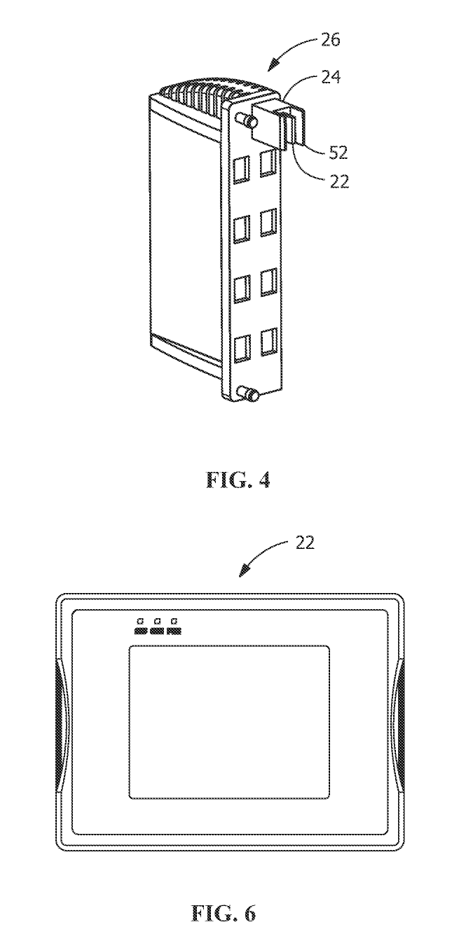

Referring to FIG. 1, a schematic diagram of an embodiment of a modular interface 10 preferably includes at least eight terminals, or contacts, connected to a hosting computer or automation system, e.g., a modular I/O and data acquisition system 20 (FIG. 3) or an HMI 22 (FIG. 6.). More terminals may be provided depending on additional optional features. In the exemplary embodiment of modular interface 10, a first pair of opposing terminals 12 is disposed at one end of modular interface 10 one opposite sides of interface 10. The pair of terminals 12 is wired to a positive voltage supply at a predetermined voltage level, e.g., 24 VDC. The positive voltage supply source may be provided from the hosting device 20, 22. A contact portion 16 in electrical communication with terminals 12 receives a contact of a mating connector 24 (see, e.g., FIG. 4) of an external device 26, e.g., input/output (I/O), control, or communications devices. A second pair of opposing terminals 14 may be connected to a common terminal of the 24 VDC power source, adjacent to the first terminal pair. A third pair of opposing terminals 18 may be connected to a USB common signal bus of the hosting device 20, 22. In addition, a USB_N or negative signal terminal 28 and a USB_P or positive signal terminal 30 are provided, and optional video terminals VIDEO_N 32 and VIDEO_P 34. Terminals 18, 28 and 30 transmit USB data signals from the hosting device 20, 22. Terminals 32, 34 transmit video signals, if present.

Video support may be optionally provided in the hardware domain, via a single differential pair in electronic communication via VIDEO_N 32 and VIDEO_P 34. Video support includes a high-speed forward channel with a full-duplex back channel. The purpose of this is to support a video input module. A video input module (not shown) sends image data down the forward channel, directly into the graphics accelerator, e.g., on the hosting platform 20, 22, through a suitable hardware decoder, with a corresponding encoder on the video input module. This Serializer (module)-Deserializer (host) approach yields a narrow serial stream, without compromising the bandwidth of the video link. The result of the video channel is to provide parallel bus performance with two wires. The source video feed may be remotely controlled by the full-duplex back channel that supports I²C. Normally a system with USB would encode video over it, but this puts a big burden on the hosting system processor, especially of an embedded system. By providing a specific hardware channel for video, system performance doesn't suffer and neither does video performance. In one exemplary embodiment, the hardware encoding system may be the National Semi Conductor Channel Link III.

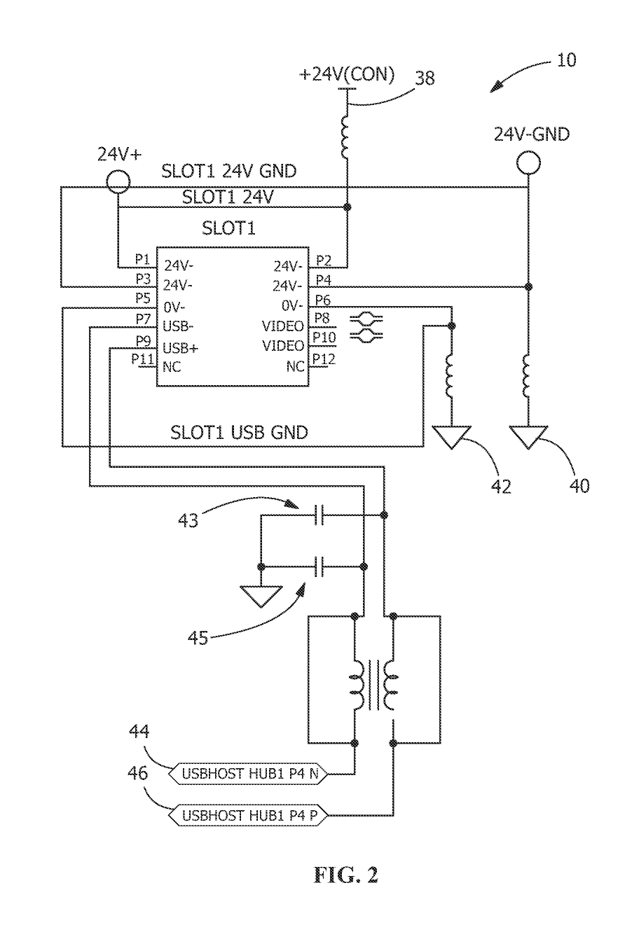

Referring next to FIG. 2, a schematic interconnection diagram shows an exemplary electrical circuit for modular interface 10. A female connector portion 36 corresponding to FIG. 1 includes terminals p1, p2 connected to a voltage source 38 through an inductor 40. Terminals p3, p4 are connected to a −24 volt source 40, and terminals p5, p6 are connected to a zero volt or common connection 42. The voltage sources and ground connection may be provided by any conventional power supply within the hosting device 20, 22, according to the load requirements, and may be rated for higher voltage and current if desired. Terminals p7, p9 are each connected to a USB hub (not shown) located within the hosting device 20, 22. In the exemplary embodiment, terminal p7 may be connected to the USB data signal negative polarity output 44, and terminal p9 may be connected to the USB data signal positive polarity output 46. A common mode choke I31 and capacitors 43, 45 provide signal conditioning of the USB differential pair 44, 46. The standard USB V_{bus} is not used on the exemplary custom modular interface 10, although in some alternate embodiments modular interface 10 may include additional terminals that use standard USB V_{bus}. Spare terminals p11, p12, are not used in the embodiment shown.

Referring next to FIG. 3, modular I/O and data acquisition system 20 as is commonly used in industrial automation applications includes multiple ports 48 for receiving mating connector 24. A male connector 50 is located at a first end of an interconnecting I/O module 26. Male connector 50 includes contacts (not shown) that mate with contacts 16 located in ports 48. Mating connector 24 also may include alignment ribs 52 adjacent male connector 50. Alignment ribs 52 align male connector 50 with modular interface 10 to guide male connector 50 into electrical contact with modular interface 10 within a selected port 48. Ports 48 are mounted in an equipment rack 54. Equipment rack 54 includes conventional wiring interconnections, power and data buses for communication with local and remote automation components. A DIN rail 56 or similar mounting apparatus may be used to support equipment rack 54.

FIG. 4 shows an external device 26 for use with equipment rack 54 or HMI 22. As discussed above, external device 26 may be an industrial automation control device or communication device. Control devices include by way of example and not limitation, single & multiple loop PID modules, motor or servo controllers, deterministic logic controller, or other process control or automation devices. Communications devices include by way of example and not limitation, 4/8-port Ethernet switches, modems geographic positioning system (GPS) receivers, and proprietary communication protocols and systems for industrial automation, such as Foundation Fieldbus, Profibus and DeviceNet.

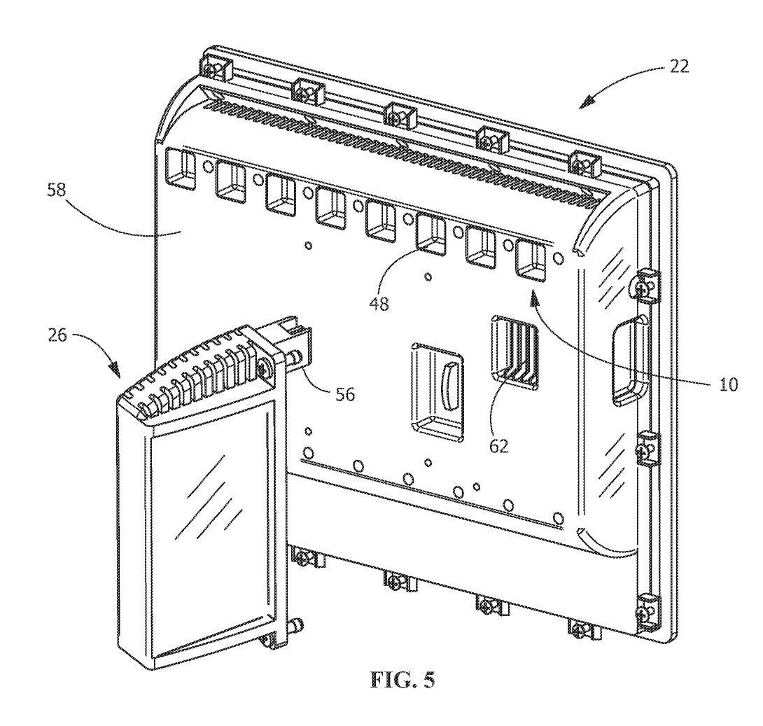

Referring next to FIG. 5, an HMI 22 includes ports 48 similar to ports shown in FIG. 3. Ports 48 are integrally mounted within the rear housing portion 58 of HMI 22, at the rear of the HMI display 60 (FIG. 6). External device 26 is preferably hot-swappable during operation of HMI 22. HMI 22 may include additional electrical interfaces 62 for power and data.

It should be understood that the application is not limited to the details or methodology set forth in the following description or illustrated in the figures. It should also be understood that the phraseology and terminology employed herein is for the purpose of description only and should not be regarded as limiting.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the custom data and power interface as shown in the various exemplary embodiments is illustrative only. Although only a few embodiments have been described in detail in this disclosure, those who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

What is claimed is:

1. An interface circuit for a modular input/output (I/O) human-machine interface (HMI) and data acquisition system, the interface circuit comprising:
a connection port having a power source, a pair of USB data signal lines transmitting a USB data signal.

2. The circuit of claim 1, wherein the connection port is an I/O port, the I/O port comprising a plurality of terminals connectable to a computer or automation system.

3. The circuit of claim 1, further comprising a first pair of terminals in electrical communication with a voltage source at a predetermined voltage level.

4. The circuit of claim 3, wherein the predetermined voltage level is 24 volts.

5. The circuit of claim 3, wherein the voltage source is the HMI or data acquisition system.

6. The circuit of claim 3, wherein the first pair of terminals is connectable to a connector of an external device.

7. The circuit of claim 6, wherein the external device comprises at least one of an input/output (I/O), a control device, or a communications device.

8. The circuit of claim 3, further comprising a second pair of terminals in electrical communication with a common terminal of the voltage source.

9. The circuit of claim 8, further comprising a third set of terminals in electrical communication with a USB common signal bus of the computer or automation system.

10. The system of claim 9, further comprising a fourth pair of terminals in electrical communication with a negative USB signal and a positive USB signal.

11. The circuit of claim 10, further comprising a video channel independent from the USB data signal, and a fifth pair of terminals configured to connect a pair of video terminals, the video channel configured to transmit USB data signals from the computer or automation system.

12. A modular I/O and data acquisition system comprising;
a plurality of connection ports for receiving mating connectors of an interconnecting I/O module, the mating connectors configured to mate with a plurality of contacts in an associated connection port;
the plurality of port mounted in an equipment rack, the equipment rack comprising conventional wiring interconnections, power and data buses for communication with one or more automation devices;
wherein at least one connection port of the plurality of connection ports comprises an interface circuit comprising:
a power source, a pair of USB data signal lines transmitting a USB data signal, and an optional video channel independent from the USB data signal.

13. The system of claim 12, further comprising an external device, wherein the external device comprises at least one of an automation control device or a communication device.

14. The system of claim 13, wherein the automation control device is one of a single loop PID module, a multiple loop PID module, a motor controller, a servo controller, a deterministic logic controller, a process control device and an automation device.

15. The system of claim 13, wherein the communication device is one of a multiple-port Ethernet switch, modem, geographic positioning system (GPS) receiver, and a proprietary communication protocol.

16. The circuit of claim 12, further comprising a first pair of terminals in electrical communication with a voltage source at a predetermined voltage level.

17. The circuit of claim 16, further comprising a second pair of terminals in electrical communication with a common terminal of the voltage source.

18. The circuit of claim 17, further comprising a third set of terminals in electrical communication with a USB common signal bus of the computer or automation system.

19. The system of claim 18, further comprising a fourth pair of terminals in electrical communication with a negative USB signal and a positive USB signal.

20. An HMI comprising:
a plurality of connection ports for receiving mating connectors of an interconnecting I/O module, the mating connectors configured to mate with a plurality of contacts in an associated connection port;
wherein at least one connection port of the plurality of connection ports comprises an interface circuit, the interface circuit comprising:
a power source, a pair of USB data signal lines transmitting a USB data signal, and an optional video channel independent from the USB data signal.
